(19) United States
(12) Patent Application Publication
(10) Pub. No.: US 2025/0289309 A1
(43) Pub. Date: Sep. 18, 2025

(54) VEHICLE DISPLAY CONTROL DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/050,427

(22) Filed: Feb. 11, 2025

(30) Foreign Application Priority Data
Mar. 12, 2024 (JP) 2024-038411

(51) Int. Cl. B60K 35/28; G06Q 30/0207

(52) U.S. Cl. CPC B60K 35/28; G06Q 30/0207; B60K 2360/171

(57) ABSTRACT

A vehicle display control device includes: a display control section that is configured to cause display of a lane image simulating a travel lane in which a host vehicle travels, and an icon indicating an incentive that can be acquired by the host vehicle passing through the travel lane, at a display region provided at a periphery of a driver's seat of the host vehicle.

### CROSS-REFERENCE TO RELATED APPLICATION

This application is based on and claims priority under 35 USC § 119 from Japanese Patent Application No. 2024-038411 filed on Mar. 12, 2024, the disclosure of which is incorporated by reference herein.

### TECHNICAL FIELD

The present disclosure relates to a vehicle display control device.

### RELATED ART

Japanese Patent Application Laid-Open (JP-A) No. 2023-028544 (Patent Document 1) discloses an incentive providing system in which reward points are provided to a user who performs CO₂ reduction travel by selecting a travel route (a CO₂ reduction route) that reduces CO₂ emissions with respect to a reference travel route during vehicle travel from a current location to a destination.

Although the technology described in Patent Document 1 can add an incentive to reducing CO₂ emissions, there is room for improvement regarding providing an incentive to travel safely.

### SUMMARY

The present disclosure has been made in consideration of the above circumstances, and an object of the present disclosure is to provide a vehicle display control device that is capable of causing display of an incentive added to a guide used by a driver to perform safe driving.

A vehicle display control device according to a first aspect includes: a display control section that is configured to cause display of a lane image simulating a travel lane in which a host vehicle travels, and an icon indicating an incentive that can be acquired by the host vehicle passing through the travel lane, at a display region provided at a periphery of a driver's seat of the host vehicle. The vehicle display control device according to the first aspect enables an incentive to be added to a guide used by a driver to perform safe driving and displayed.

A vehicle display control device according to a second aspect is the vehicle display control device according to the first aspect, wherein: the vehicle display control device includes an acquisition section that is configured to acquire a path of the travel lane which enables the host vehicle to pass through safely; and the display control section is configured to cause display of the icon at a position on the lane image that corresponds to the acquired path of the travel lane. The vehicle display control device according to the second aspect enables the driver to be prompted to pass through the path analyzed to be able to be passed through safely.

A vehicle display control device according to a third aspect is the vehicle display control device according to the first or the second aspect, wherein: the display control section is configured to cause display of the icon in a case in which the acquired path of the travel lane is in a straight-ahead direction. The vehicle display control device according to the third aspect enables the driver to be prompted to travel straight in the straight-ahead direction.

A vehicle display control device according to a fourth aspect is the vehicle display control device according to any one of the first aspect to the third aspect, wherein: the display control section is configured to change, and cause display of, the icon based on a speed of the host vehicle and a speed limit of the travel lane. Therefore, the vehicle display control device according to the fourth aspect enables the driver to be prompted to travel at a speed that does not exceed the limit speed.

A vehicle display control device according to a fifth aspect is the vehicle display control device according to any one of the first aspect to the fourth aspect, wherein: in a case in which there is a stop position, in the travel lane, at which stopping of the host vehicle is required, the display control section is configured to change, and cause display of, the icon based on a period of time during which the host vehicle is stopped at the stop position. The vehicle display control device according to the fifth aspect enables the driver to be prompted to stop the host vehicle.

According to the present disclosure, an incentive can be added to a guide used by a driver to perform safe driving and displayed.

### BRIEF DESCRIPTION OF DRAWINGS

FIG. 1 is a block diagram illustrating a hardware configuration of a vehicle display control device according to an exemplary embodiment.

FIG. 2 is a block diagram illustrating a functional configuration of a vehicle display control device according to an exemplary embodiment.

FIG. 3 is an example of a display screen of a second display 26 in a case in which a path of a host vehicle is in a straight-ahead direction during manual driving.

FIG. 4A is an example of a display screen of the second display 26 in a case in which display of icons changes during manual driving.

FIG. 4B is an example of a display screen of the second display 26 in a case in which display of icons changes during manual driving.

FIG. 4C is an example of a display screen of the second display 26 in a case in which display of icons changes during manual driving.

FIG. 5 is a flowchart illustrating an example of a flow of display processing in an exemplary embodiment.

FIG. 6 is a flowchart illustrating an example of a flow of providing processing in an exemplary embodiment.

### DETAILED DESCRIPTION

Explanation follows regarding a vehicle display control device 10 installed at a vehicle 12 (hereinafter also referred to as a host vehicle) according to an exemplary embodiment, with reference to the drawings. The vehicle 12 is an example of a “host vehicle”.

### Hardware Configuration of the Vehicle Display Control Device 10

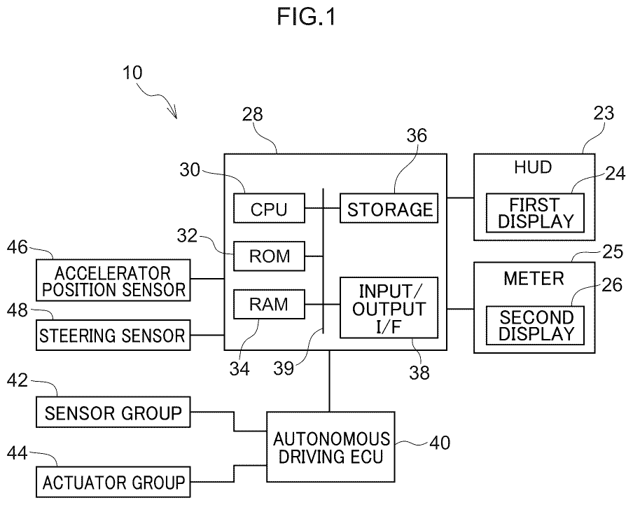

As illustrated in FIG. 1, the vehicle display control device 10 of the present exemplary embodiment includes an electronic control unit (ECU) 28.

The ECU 28 includes a central processing unit (CPU; serving as a processor) 30, read only memory (ROM) 32, random access memory (RAM) 34, storage 36, and an input/output interface 38. These respective configurations are communicably connected to each other via an internal bus 39.

The CPU 30 is a central processing unit that executes various programs and controls various components. Namely, the CPU 30 reads a program from the ROM 32 or the storage 36, and executes the program using the RAM 34 as a workspace. Further, the CPU 30 controls the respective configurations described above and performs a variety of computation processing in accordance with programs stored in the ROM 32 or the storage 36.

The ROM 32 stores various programs and various data. The RAM 34 serves as a workspace to temporarily store programs and data. The storage 36 is configured by a hard disk drive (HDD) or a solid state drive (SSD), and is a non-transitory storage medium that stores various programs including an operating system, as well as various data. In the present exemplary embodiment, a display program and a providing program, for performing display processing and providing processing, and the like, are stored in the ROM 32 or the storage 36. Further, various input/output devices are connected to the input/output interface 38.

The ECU 28 is electrically connected to an autonomous driving ECU 40. Similarly to the ECU 28, the autonomous driving ECU 40 includes a CPU, ROM, RAM, storage, an input/output interface, and the like, which are not illustrated in the drawings.

The autonomous driving ECU 40 is connected to a sensor group 42 that detects a current situation of the vehicle, and an actuator group 44 that controls travel of the vehicle. The sensor group 42 includes plural sensors among various sensors such as a camera, a radar, a LIDAR (light detection and ranging, or laser imaging, detection, and ranging) sensor, or a global positioning system (GPS) sensor. The camera captures an image of a periphery of the vehicle. The radar detects a distance and a direction from an object at a periphery of the vehicle using radio waves. The LIDAR sensor detects a distance and a direction from an object at a periphery of the vehicle using a laser beam. The GPS sensor detects a current position of the vehicle. In addition, the sensor group 42 includes sensors that detect a state of an occupant. For example, the sensor group 42 may include a biological sensor that detects a heart rate, a degree of arousal, and the like of an occupant.

The actuator group 44 includes an acceleration/deceleration actuator that adjusts acceleration/deceleration of the vehicle, and a steering actuator that drives a steering device of the vehicle. The autonomous driving ECU 40 performs autonomous driving of the vehicle by controlling operation of the actuator group 44 in accordance with the current situation of the vehicle which is detected by the sensor group 42. Note that a storage section of the autonomous driving ECU 40 stores a scheduled path that represents a path along which the vehicle is scheduled to travel, and the autonomous driving ECU 40 causes the vehicle to travel along the scheduled path stored in the storage section.

A head-up display device 23 and a meter 25 are connected to the ECU 28. A first display 24 is configured by a projection plane that is projected by the head-up display device 23. Further, a second display 26 is a display displayed at the meter 25, and the meter 25 is located facing a driver's seat, at an instrument panel (not illustrated in the drawings) provided at a front part inside a vehicle cabin of the vehicle 12. The first display 24 and the second display 26 are provided at positions that are visible to a driver. In this manner, a vehicle display system is configured by the vehicle display control device 10, the first display 24, and the second display 26. The first display 24 and the second display 26 are examples of “display regions provided at a periphery of the driver's seat”.

An accelerator position sensor 46 and a steering sensor 48 are connected to the ECU 28. The accelerator position sensor 46 is a sensor that detects a position of a non-illustrated accelerator pedal provided at a lower portion of the driver's seat. Further, the steering sensor 48 is a sensor that detects a load applied to a steering wheel 16 by an occupant. Namely, the steering sensor 48 of the present exemplary embodiment is configured not to detect a load in a case in which the steering wheel 16 is being operated by the autonomous driving ECU 40 during autonomous driving, but to detect a load in a case in which an occupant is operating the steering wheel 16.

### Functional Configuration of the Vehicle Display Control Device 10

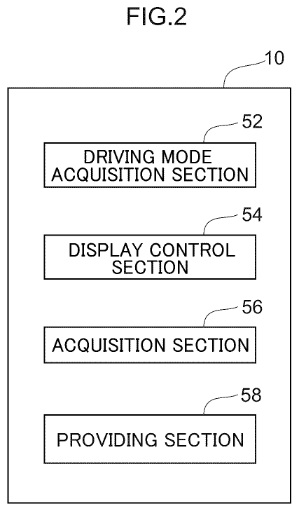

The vehicle display control device 10 implements various functions using the above-described hardware resources. Explanation follows regarding functional configurations implemented by the vehicle display control device 10, with reference to FIG. 2.

As illustrated in FIG. 2, the functional configuration of the vehicle display control device 10 includes a driving mode acquisition section 52, a display control section 54, an acquisition section 56, and a providing section 58. The respective functional configurations are implemented by the CPU 30 of the ECU 28 reading and executing a program.

The driving mode acquisition section 52 acquires whether a driving mode of the vehicle 12 is a manual driving mode or an autonomous driving mode. Note that the manual driving mode in the present exemplary embodiment refers to a driving mode in which the vehicle 12 is traveling via driving operation of an occupant. Moreover, the autonomous driving mode in the present exemplary embodiment refers to a driving mode in which the vehicle 12 is traveling without intervention of an accelerator operation by an occupant. An example of the autonomous driving mode of the present exemplary embodiment is during operation of adaptive cruise control (ACC). The ACC is a driving assistance function that uses a camera and a radar (monocular camera and millimeter-wave radar) included in the sensor group 42 to recognize a preceding vehicle, and supports following travel while maintaining a following distance in accordance with vehicle speed. The driving mode acquisition section 52 acquires information relating to a driving mode based on, for example, a signal from the autonomous driving ECU 40.

The display control section 54 causes display of peripheral information for the vehicle 12 at the first display 24 and the second display 26 which are provided inside the vehicle cabin. More specifically, the display control section 54 acquires a signal from the sensor group 42, and causes display of peripheral information for the vehicle 12 at the first display 24 and the second display 26 based on the acquired signal.

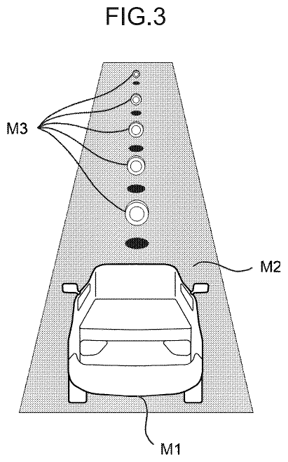

Moreover, in a case in which the driving mode acquired by the driving mode acquisition section 52 is at least the manual driving mode, the display control section 54 causes display of icons, at the first display 24 and the second display 26, indicating acquirable incentives. More specifically, the display control section 54 causes display of incentive icons M3 (see FIG. 3) at positions corresponding to the path acquired by the acquisition section 56, which is described below, at the display regions of the first display 24 and the second display 26. Moreover, the display control section 54 causes display of the incentive icons M3 in a coordinated manner at locations corresponding to once-displayed positions. Namely, as the vehicle 12 approaches locations corresponding to the positions at which the incentive icons M3 are displayed, the display control section 54 causes display of the incentive icons M3 in an enlarged manner at lower portions of the display regions of the first display 24 and the second display 26. Moreover, in a case in which it is determined by the providing section 58, which is described below, that an incentive icon M3 has been acquired, the display control section 54 causes the incentive icon M3 to be hidden. Each of the incentive icons M3 is an example of an “icon”.

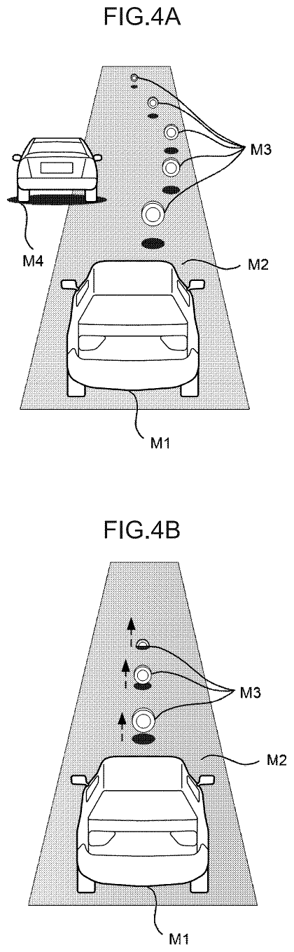

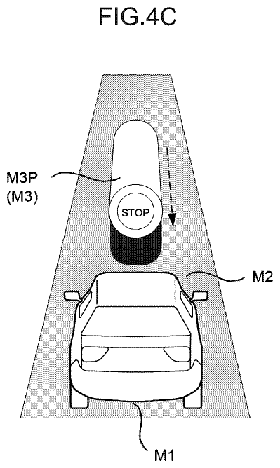

Moreover, the display control section 54 changes, and causes display of, the incentive icons M3 in accordance with a speed of the vehicle 12 and a maximum speed of the travel lane in which the vehicle 12 travels. More specifically, the display control section 54 causes the plural incentive icons M3 to be displayed gradually, and does not completely display the plural incentive icons M3 in a case in which the speed of the vehicle 12 exceeds the maximum speed of the travel lane. The maximum speed is an example of a “speed limit”. Moreover, the display control section 54 changes, and causes display of, an incentive icon M3P (see FIG. 4C) at a position at which a temporary stop is required, in accordance with the time during which the vehicle 12 is stopped. Note that positions at which a temporary stop is required include immediately before a stop line according to a road sign or the like which indicates a temporary stop, before a crosswalk or the like at which a pedestrian or the like is present, immediately before crossing a railroad crossing, and the like. More specifically, the display control section 54 causes display of the incentive icon M3P while changing a length of the incentive icon M3P from a length indicating a predetermined period of time (for example, three seconds), serving as a period of time of a temporary stop, to a shorter length in accordance with the period of time during which the vehicle 12 is stopped. A position at which a temporary stop is required is an example of “a stop position at which stopping of the host vehicle is required”. The incentive icon M3P is an example of an “icon”.

The acquisition section 56 acquires a path that enables the vehicle 12 to travel safely. More specifically, the acquisition section 56 acquires a path that enables the vehicle 12 to travel safely, which has been analyzed by the autonomous driving ECU 40. A path that enables the vehicle 12 to travel safely is an example of “a path of a travel lane that enables the host vehicle to pass through safely”.

The providing section 58 provides an incentive to a driver who performs safe driving. More specifically, in a case in which the providing section 58 determines that an incentive icon M3 has been acquired, the providing section 58 provides an incentive to the driver. For example, in a case in which a position at which a host vehicle image M1 (see FIG. 3) simulating the vehicle 12 is displayed and a position at which an incentive icon M3 (see FIG. 3) is displayed overlap with each other, the providing section 58 determines that the incentive icon M3 has been acquired. Namely, in a case in which the vehicle 12 has reached a location corresponding to the displayed position of an incentive icon M3, the providing section 58 determines that the incentive icon M3 has been acquired.

Note that a case in which a position at which the host vehicle image M1 is displayed and a position at which an incentive icon M3 is displayed overlap with each other refers to a case in which the coordinates of the host vehicle image M1 and the coordinates of the incentive icon M3 at the first display 24 and the second display 26 are close to a predetermined range, or a case in which the spatial coordinates corresponding to the host vehicle image M1 and the spatial coordinates corresponding to the incentive icon M3 are close to a predetermined range. The incentive provided to the driver is, for example, an event that appeals to the five senses of the driver during driving, such as points that can be exchanged for various goods or services, or sound effects, effect displays, or vibration of the steering wheel. As an example, the driver can exchange acquired points with a replacement panel that changes the ornamentation of the meter 25. Note that a determination region may be provided at a portion of the host vehicle image M1 so as to determine that an incentive icon M3 has been acquired only in a case in which the determination region and the position at which the incentive icon M3 is displayed overlap with each other. Alternatively, in a case in which it is determined that an incentive icon M3 has been acquired in a state in which the incentive icon M3 is not fully displayed, the incentive may not be provided.

Explanation follows regarding a portion of the display screen of the second display 26 displayed by the functionality of the display control section 54 during manual driving, with reference to FIG. 3 and FIG. 4A to FIG. 4C.

FIG. 3 is an example of a display screen of the second display 26 in a case in which the path of the vehicle 12 is in the straight-ahead direction. As illustrated in FIG. 3, the second display 26 displays the host vehicle image M1, the lane image M2 simulating the travel lane in which the vehicle 12 travels, and the incentive icons M3. Note that the incentive icons M3 may be displayed not only in a case in which the travel lane is substantially linear, but also in a case in which the travel lane is a curve without a branch.

The host vehicle image M1 is displayed at a display region within the second display 26. The host vehicle image M1 is displayed superimposed on the lane image M2 at the lower portion of the display region. As an example, in FIG. 3, the host vehicle image M1 is displayed as an image indicating a white passenger vehicle.

The lane image M2 is displayed superimposed on the host vehicle image M1 and the incentive icons M3. As an example, in FIG. 3, the lane image M2 is displayed as a gray trapezoid. Note that in a case in which the travel lane is curved, the lane image M2 may be displayed curved so as to indicate the curve.

Plural incentive icons M3 are displayed superimposed on the lane image M2 ahead of the host vehicle image M1, and five incentive icons M3 are displayed in FIG. 3. Note that “ahead of the host vehicle image M1” is a direction of travel of the vehicle 12, and coincides with an upward direction at the second display 26. Moreover, a display position and a size of the incentive icon M3 are changed and displayed in accordance with the relative positional relationship with the host vehicle image M1. For example, in FIG. 3, plural incentive icons M3 are displayed in a liner arrangement as circular icons floating on the lane image M2, and are displayed in a reduced manner at the upper portion of the display region within the second display 26 as they move away from the host vehicle image M1. Note that the shape of the incentive icons M3 is not limited to a circle, and may be various shapes such as a triangle, a quadrilateral, a star, or a heart.

Moreover, as the vehicle 12 approaches a location corresponding to the position at which an incentive icon M3 is displayed, the incentive icon M3 is displayed at a near side. Note that the “near side” is a direction approaching the host vehicle image M1, and coincides with a downward direction on the second display 26. More specifically, the incentive icon M3 is gradually moved to the near side of the host vehicle image M1 at a speed in accordance with the speed at which the vehicle 12 travels, and displayed. Note that the incentive icons M3 may be displayed so that an interval between incentive icons M3 is changed in accordance with the speed of the vehicle 12. For example, in a case in which the speed of the vehicle 12 is slower than the state that is illustrated in FIG. 3, the interval between the incentive icons M3 is displayed small. Conversely, in a case in which the speed of the vehicle 12 is faster than the state that is illustrated in FIG. 3, the interval between the incentive icons M3 is displayed so as to be wider.

By causing display of the incentive icons M3 superimposed on the lane image M2 in this manner, a path that enables the vehicle 12 to travel safely is displayed. Moreover, the incentive icons M3 are gradually moved to the near side and displayed, thereby indicating that the vehicle 12 is traveling.

FIG. 4A to FIG. 4C are examples of display screens of the second display 26 in cases in which the display of icons changes. As illustrated in FIG. 4A to FIG. 4C, the incentive icons M3 change in accordance with the peripheral situation and the situation of the vehicle 12, and are displayed.

As illustrated in FIG. 4A, in a case in which the vehicle 12 has detected another vehicle that is parked such that it protrudes into the travel lane, an other vehicle image M4 simulating the other vehicle is displayed. The incentive icons M3 are displayed on a path that avoids the other vehicle image M4. By causing display of the incentive icons M3 on a path that avoids the other vehicle image M4 in this manner, a path that enables the vehicle 12 to travel safely is displayed. A path that avoids the other vehicle image M4 is an example of “a path on a lane image”.

As illustrated in FIG. 4B, plural incentive icons M3 are displayed in a state in which they gradually ascend from a position corresponding to a road surface of the lane image M2 one by one from a near side, and are on the way up to the position displayed in FIG. 3. Note that “ascend” means advancing in the direction indicated by the dashed arrows in FIG. 4B. In a case in which a speed of the vehicle 12 has exceeded a maximum speed of the travel lane, the incentive icon M3 is not displayed in a state in which the incentive icon M3 has been fully raised as the vehicle 12 advances forward in the host vehicle image M1 (see FIG. 3). More specifically, three of the incentive icons M3 are incompletely displayed from the near side of the host vehicle image M1, while two of the incentive icons M3 are not displayed at a far side. Note that the “far side” is a direction away from the host vehicle image M1, and coincides with the upward direction on the second display 26. Moreover, the first incentive icon M3 from the near side is displayed in a state in front of the vehicle 12 so as to be completely elevated, the second incentive icon M3 from the near side is displayed in contact with the lane image M2, and the third incentive icon M3 from the near side is displayed so as to be half-buried in the lane image M2. Further, the fourth and fifth incentive icons M3 from the near side are completely hidden. As described above, the incentive icons M3 are displayed ascending in order from the near side of the host vehicle image M1, and the incentive icons M3 positioned at the far side of the host vehicle image M1 are not displayed, thereby indicating that the speed of the vehicle 12 has exceeded the maximum speed of the travel lane.

As illustrated in FIG. 4C, a horizontal cylindrical incentive icon M3P is displayed at a position ahead of the host vehicle image M1 at which a temporary stop is required, with a near side of horizontal cylindrical incentive icon M3P serving as a bottom surface thereof and the horizontal cylindrical incentive icon M3P having a height toward the far side. The height of the incentive icon M3P indicates a predetermined period of time during which the vehicle 12 is temporarily stopped, and the height of the incentive icon M3P is changed to the near side (in the direction of the dashed arrow in FIG. 4C) in accordance with the period of time during which the vehicle 12 is stopped at a position that requires a temporary stop, and displayed. By displaying the incentive icon M3P, which has a height that changes in accordance with the period of stop time of the vehicle 12, in this manner, it is displayed that it is necessary to temporarily stop the vehicle 12. Note that while the vehicle 12 is stopped for a predetermined period of time, incentives may be continuously provided to the driver. The shape of the incentive icon M3P is not limited to a cylindrical shape, and may be a solid columnar shape having various shapes, such as a triangle, a quadrilateral, a star, or a heart shape as a bottom surface.

Note that although explanation has been given regarding an example of a display screen of the second display 26 in the explanation of FIG. 3 and FIG. 4A to FIG. 4C above, in the present exemplary embodiment, a configuration may be made such that the display screen is displayed at at least one of the first display 24 or the second display 26. Further, in a case in which the display region of the first display 24 is smaller than the display region of the second display 26, the first display 24 may be configured so as to display a partial image (for example, only the incentive icons M3) of the second display 26.

### Operation

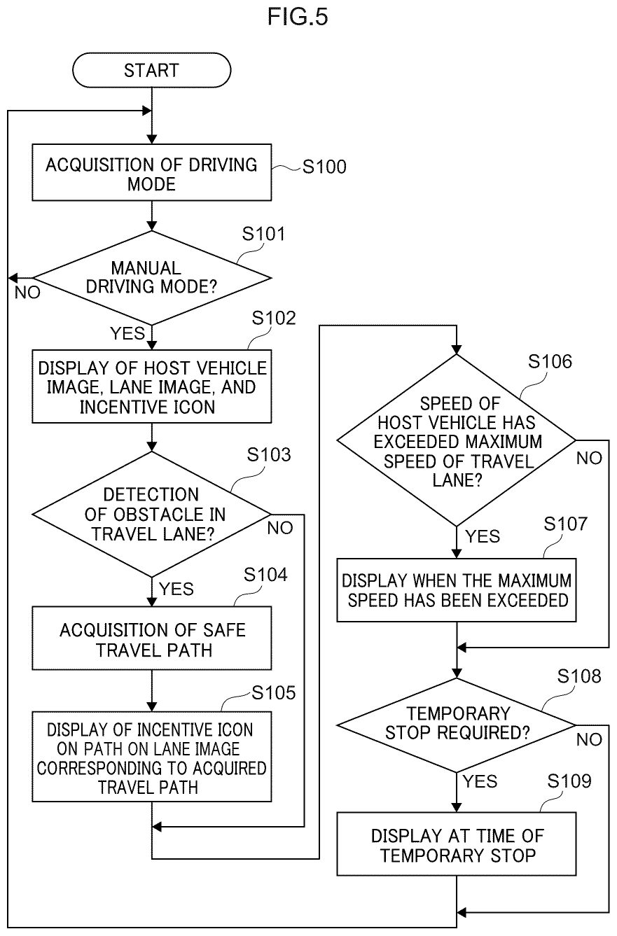

FIG. 5 is a flowchart illustrating an example of a flow of display processing performed by the vehicle display control device 10. The display processing is executed by the CPU 30 of the ECU 28 reading a program from the ROM 32 or the storage 36, and loading and executing the program in the RAM 34. As an example, the display processing illustrated in FIG. 5 is repeatedly executed during travel of the vehicle 12 in a case in which the driver selects to display the incentive icons M3.

At step S100 in FIG. 5, the CPU 30 acquires the driving mode. More specifically, the CPU 30 acquires whether the driving mode of the vehicle 12 is the manual driving mode or the autonomous driving mode.

At step S101, the CPU 30 determines whether or not the driving mode is the manual driving mode. In a case in which the CPU 30 determines that the driving mode is the manual driving mode (step S101: YES), the processing proceeds to step S102. On the other hand, in a case in which the CPU 30 determines that the driving mode is not the manual driving mode (step S101: NO), the processing returns to step S100.

At step S102, the CPU 30 causes display of the host vehicle image M1, the lane image M2, and the incentive icons M3. More specifically, the CPU 30 causes display of the host vehicle image M1, the lane image M2, and plural incentive icons M3 at the display region of the second display 26 (see FIG. 3).

At step S103, the CPU 30 determines whether or not an obstacle has been detected in the travel lane. In a case in which the CPU 30 determines that an obstacle has been detected in the travel lane (step S103: YES), the processing proceeds to step S104. On the other hand, in a case in which the CPU 30 determines that an obstacle has not been detected in the travel lane (step S103: NO), the processing proceeds to step S106.

At step S104, the CPU 30 acquires a safe travel path. More specifically, the CPU 30 acquires a path that enables the vehicle 12 to travel while avoiding the obstacle detected at step S103.

At step S105, the CPU 30 causes display of the incentive icons M3 on a path on the lane image that corresponds to the acquired path. More specifically, the CPU 30 causes display of plural incentive icons M3 at positions corresponding to the path acquired at step S104 at the display region of the second display 26 (see FIG. 4A).

At step S106, the CPU 30 determines whether or not the speed of the host vehicle has exceeded the maximum speed of the travel lane. In a case in which the CPU 30 determines that the speed of the vehicle 12 has exceeded the maximum speed of the travel lane (step S106: YES), the processing proceeds to step S107. On the other hand, in a case in which the CPU 30 determines that the speed of the vehicle 12 has not exceeded the maximum speed of the travel lane (step S106: NO), the CPU 30 proceeds to step S108.

At step S107, the CPU 30 causes display when the maximum speed has been exceeded. More specifically, the CPU 30 causes display of the plural incentive icons M3, which are displayed at the display region of the second display 26, in a state in which they are in the middle of ascending up, or hides the plural incentive icons M3 which are displayed at the display region of the second display 26 (see FIG. 4B).

At step S108, the CPU 30 determines whether or not a temporary stop is required. In a case in which the CPU 30 determines from the peripheral information for the vehicle 12 that a temporary stop is required (step S108: YES), the processing proceeds to step S109. On the other hand, in a case in which the CPU 30 determines from the peripheral information for the vehicle 12 that a temporary stop is not required (step S108: NO), the processing returns to step S100.

At step S109, the CPU 30 causes display at the time of a temporary stop. More specifically, the CPU 30 causes display of the incentive icon M3P at the display region of the second display 26 (see FIG. 4C). The CPU 30 then returns to step S100.

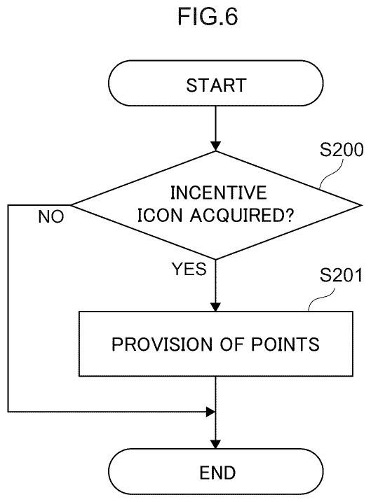

FIG. 6 is a flowchart illustrating an example of a flow of providing processing performed by the vehicle display control device 10. The providing processing is executed by the CPU 30 of the ECU 28 reading a program from the ROM 32 or the storage 36, and loading and executing the program in the RAM 34. As an example, the providing processing illustrated in FIG. 6 is repeatedly executed during travel of the vehicle 12.

At step S200 in FIG. 6, the CPU 30 determines whether or not an incentive icon M3 has been acquired. In a case in which the CPU 30 determines that the incentive icon M3 has been acquired (step S200: YES), the processing proceeds to step S201. On the other hand, in a case in which the CPU 30 determines that the incentive icon M3 has not been acquired (step S200: NO), the providing processing is ended.

At step S201, the CPU 30 provides points. More specifically, the CPU 30 provides points to the driver of the vehicle 12. Note that the provided points may be managed by a non-illustrated external server or the like in association with information for the driver. The CPU 30 then ends the providing processing. Note that the points are not limited to being provided each time it is determined that an incentive icon M3 has been acquired. For example, points may be provided in a case in which only a predetermined number (for example, ten) of incentive icons M3 have been acquired, or points may be provided (settled) in accordance with the number of acquired incentive icons M3 up to the point in time of arrival at a destination.

As described above, the vehicle display control device 10 according to the present exemplary embodiment causes display of the lane image M2 and the incentive icons M3 at the second display 26 that is provided at a periphery of the driver's seat of the vehicle 12. Accordingly, the vehicle display control device 10 of the present exemplary embodiment enables an incentive to be added to a guide used by a driver to perform safe driving and displayed.

The vehicle display control device 10 according to the present exemplary embodiment causes display of the incentive icons M3 on a path that avoids the other vehicle image M4, which corresponds to a path that enables the vehicle 12 to travel safely. Accordingly, the vehicle display control device 10 of the present exemplary embodiment enables the driver to be prompted to travel on a path analyzed to be capable of providing safe travel.

In the vehicle display control device 10 according to the present exemplary embodiment, in a case in which the path on which the vehicle 12 travels is a straight-ahead direction, the incentive icons M3 are displayed. Accordingly, the vehicle display control device 10 of the present exemplary embodiment enables the driver to be prompted to travel straight in the straight-ahead direction.

In the vehicle display control device 10 according to the present exemplary embodiment, in a case in which the speed of the vehicle 12 exceeds the maximum speed of the travel lane, the incentive icons M3 are not completely displayed. Accordingly, the vehicle display control device 10 of the present exemplary embodiment enables the driver to be prompted to travel at a speed that does not exceed the speed limit.

In the vehicle display control device 10 according to the present exemplary embodiment, the incentive icon M3P is shortened and displayed at a position at which a temporary stop of the vehicle 12 is required, in accordance with the period of time during which the vehicle 12 is stopped. Accordingly, the vehicle display control device 10 according to the present exemplary embodiment enables the driver to be prompted to temporarily stop the vehicle 12.

### Other Exemplary Embodiments

Although in the above-described exemplary embodiment the vehicle display control device 10 causes display of the incentive icons M3 during manual driving, there is no limitation thereto. The vehicle display control device 10 may cause display of the incentive icon M3 during autonomous driving. The vehicle display control device 10 according to the present exemplary embodiment enables the driver to perform safe driving that enables the driver to acquire an incentive while concentrating on steering wheel operation.

The vehicle display control device 10 may cause the incentive icons M3 to be hidden based on the steering wheel operation of the driver. For example, the vehicle display control device 10 causes the incentive icons M3 to be hidden when the driver makes a sharp turn on the steering wheel.

The vehicle display control device 10 may cause the incentive icons M3 to be hidden based on the period of time during which the driver is watching the incentive icons M3 during driving operation. For example, in a case in which the driver watches the incentive icons M3 for two seconds or longer, the vehicle display control device 10 causes the incentive icons M3 to be hidden.

The vehicle display control device 10 may change, and cause display of, the incentive icons M3 in a case in which a speed of the vehicle 12 falls below a minimum speed. More specifically, the vehicle display control device 10 does not cause complete display of the plural incentive icons M3 in a case in which the speed of the vehicle 12 is below the minimum speed of the travel lane. For example, in FIG. 3, the first and second incentive icons M3 from the near side of the host vehicle image M1 are hidden, and the third and subsequent incentive icons M3 from the near side are displayed.

Note that the control processing executed by the CPU 30 reading and executing software (a program) in the above-described exemplary embodiment may be executed by any of various types of processors other than a CPU. Examples of such processors include a Programmable Logic Device (PLD) in which the circuit configuration can be modified post-manufacture, such as a Field-Programmable Gate Array (FPGA), or a specialized electric circuit that is a processor with a specifically-designed circuit configuration for executing specific processing, such as an Application Specific Integrated Circuit (ASIC). Further, the control processing may be executed by one of these various types of processors, or may be executed by combining two or more of the same type or different types of processors (for example, plural FPGAs, or a combination of a CPU and an FPGA, or the like). Moreover, a hardware configuration of the various processors is specifically formed as an electric circuit combining circuit elements such as semiconductor elements.

In addition, although explanation has been given regarding an aspect in which a program is stored (installed) in advance in the ROM 32 or the storage 36 in the above-described exemplary embodiment, there is no limitation thereto. The programs may be provided in a format recorded on a recording medium such as compact disc read only memory (CD-ROM), digital versatile disc read only memory (DVD-ROM), or universal serial bus (USB) memory. Alternatively, the programs may be provided in a format downloadable from an external device via a network.

What is claimed is:

1. A vehicle display control device, comprising:
a processor that is configured to cause display of a lane image simulating a travel lane in which a host vehicle travels, and an icon indicating an incentive that can be acquired by the host vehicle passing through the travel lane, at a display region provided at a periphery of a driver's seat of the host vehicle.

2. The vehicle display control device according to claim 1, wherein:
the processor is configured to acquire a path of the travel lane which enables the host vehicle to pass through safely, and to cause display of the icon at a position on the lane image that corresponds to the acquired path of the travel lane.

3. The vehicle display control device according to claim 2, wherein:
the processor is configured to cause display of the icon in a case in which the acquired path of the travel lane is in a straight-ahead direction.

4. The vehicle display control device according to claim 1, wherein:
the processor is configured to change, and cause display of, the icon based on a speed of the host vehicle and a speed limit of the travel lane.

5. The vehicle display control device according to claim 1, wherein:
in a case in which there is a stop position, in the travel lane, at which stopping of the host vehicle is required, the processor is configured to change, and cause display of, the icon based on a period of time during which the host vehicle is stopped at the stop position.
